(19) United States
(12) Patent Application Publication
(10) Pub. No.: US 2003/0055793 A1
(43) Pub. Date: Mar. 20, 2003

(54) Method, apparatus and program storage device for sorting negotiable instruments

(76) Inventors: Michael A. Charles, Manchester Center, VT (US); Douglas J. Landholt, St. Louis, MO (US); Ronald L. Ratzlaff, Sandy, OR (US); Stuart D. Hunt, Willis, MI (US)

Correspondence Address: Victor Cardona, Esq., Heslin Rothenberg Farley & Mesiti P.C., 5 Columbia Circle, Albany, NY, 12203, US

(21) Appl. No.: 09/952,740

(22) Filed: Sep. 14, 2001

(51) Int. Cl. H04K 1/00

(52) U.S. Cl. 705/80

(57) ABSTRACT

Negotiable instruments are sorted by electronically obtaining information from a plurality of negotiable instruments, electronically storing the information, electronically retrieving at least some of the stored information and electronically storing the at least some of the information indexed to at least one location. Further, the negotiable instruments may be sent to the at least one location based on the information.

The U.S. Government has a paid-up license in this invention and the rights in limited circumstances to require the patent owner to license others on reasonable terms as provided for by the terms of a contract between Applicant and the Federal Reserve Bank of Richmond, which was assigned to the Federal Reserve Bank of Cleveland.

### TECHNICAL FIELD

This invention relates generally to the item processing industry, and more particularly to sorting negotiable instruments.

### BACKGROUND OF THE INVENTION

Checks or negotiable instruments must be returned to their originating banks after they have been endorsed and “cashed” by a customer. Receiving banks or other financial institutions must sort the negotiable instruments according to their original maker to allow them to be easily packaged and shipped back to this maker. Thus, mechanical sorters operated by controllers driven by software systems are utilized to divide large amounts of checks according to their final destinations. Bundles of checks resulting from the use of these sorters must be packaged along with documentation of the contents of each bundle prior to shipment. Multiple bundles might also be packaged for shipment to a common destination along with documentation regarding the multiple bundles.

Many software systems which drive the mechanical sorters require an entire quantity of checks to be processed by the sorter before documentation required for shipment can be prepared. Thus, when a large amount of checks is input to a sorter, the entire quantity of checks must await completion of the sorting task to allow preparation of documentation to accompany the checks to their destination.

Thus, there is a need for sorting negotiable instruments which allows the documentation necessary for shipment to be prepared prior to the completion of a sorting task.

### SUMMARY OF THE INVENTION

The present invention provides, in a first aspect, a method of sorting negotiable instruments. The method includes electronically obtaining information from a plurality of negotiable instruments, electronically storing the information, electronically retrieving at least some of the stored information and electronically storing the at least some of the information indexed to at least one location.

The present invention provides, in a second aspect, a system for sorting negotiable instruments, including means for electronically obtaining information from a plurality of negotiable instruments, means for electronically storing the information, means for electronically retrieving at least some of the stored information and means for electronically storing the at least some of the information indexed to at least one location.

The present invention provides, in a third aspect, at least one program storage device readable by a machine, tangibly embodying at least one program of instructions executable by the machine to perform a method for sorting negotiable instruments. The method includes electronically obtaining information from a plurality of negotiable instruments, electronically storing the information, electronically retrieving at least some of the stored information and electronically storing the at least some of the stored information indexed to at least one location.

### BRIEF DESCRIPTION OF THE DRAWINGS

The subject matter which is regarded as the invention is particularly pointed out and distinctly claimed in the claims at the conclusion of the specification. The foregoing and other features and advantages of the invention will be readily understood from the following detailed description of preferred embodiments, taken in conjunction with the accompanying drawings, in which:

FIG. 1 is a block diagram of an apparatus for sorting negotiable instruments in accordance with the present invention;

FIG. 2 illustrates an example of a kill list in accordance with the present invention.

FIG. 3 is a flow diagram of a method of sorting negotiable instruments in accordance with the present invention;

FIG. 4 illustrates an example of a status report in accordance with the present invention;

FIG. 5 illustrates an example of a textual display of information relating to a plurality of checks in accordance with the present invention; and

FIG. 6 is a flow diagram of another method for sorting negotiable instruments in accordance with the present invention.

### DETAILED DESCRIPTION

In accordance with the principles of the present invention, methods for sorting negotiable instruments and apparatus for performing the methods are provided. The method includes electronically obtaining information from a plurality of negotiable instruments, electronically storing the information, electronically retrieving at least some of the stored information and electronically storing at least some of the retrieved information indexed to at least one location. The electronically obtaining, the electronically storing, the electronically retrieving, and the electronically storing at least some of the retrieved information may occur concurrently. The method may further include sending the plurality of negotiable instruments to a plurality of locations based on the information.

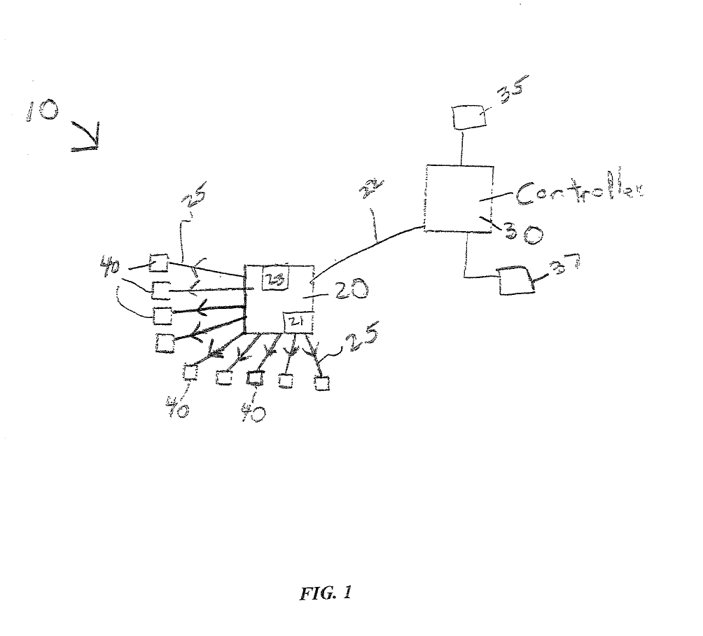

In one example depicted in FIG. 1, a system 10 for sorting negotiable instruments includes a sorter 20 coupled to a computing unit 30. Sorter 20 may include a plurality of pockets 40 for receiving negotiable instruments or checks. Also, sorter 20 may include a sorter controller 23 integral to or separate from sorter 20 for controlling reading, sorting and performing other functions of sorter 20. A reader or scanner portion 21 of sorter 20 may read or scan indicia or symbols from the negotiable instruments and based thereon sorter controller 23 may cause sorter 20 to send the negotiable instruments to pockets 40.

Computing unit 30 may be a processor or computing unit, for example, an IBM mainframe or server, a Hewlett Packard system running HP-UX, a Unix derivative Operating System, or a personal computer, such as a personal computer with Microsoft WINDOWS as the operating system, and based on the Intel PC architecture. Computing unit 30 includes, for example, one or more central processing units, memory, one or more storage devices and one or more input/output devices, as is well known in the art. For example, computing unit 30 may have a display 35 to enable visual output for viewing by a user.

Computing unit 30 may be coupled to sorter 20 via a standard connection 22, such as any type of wire connection, token ring or network connection, to name just a few examples. One example of a communications protocol used by one or more of these connections is TCP/IP which allows connection to a computer network, such as, for example, a local area network or a global computer network (e.g., the INTERNET).

Sorter 20 captures images of the negotiable instruments. For example, sorter 20 might digitize or microfilm an image of each negotiable instrument processed and might read or optically scan indicia printed or encoded on the surface of the negotiable instrument. Also, these indicia might be Optical Character Recognition (OCR) symbols or Magnetic Ink Character Recognition (MICR) characters, as are known by those skilled in the art. Further, images of negotiable instruments may be read by an image character recognition based system. Information relating to the negotiable instruments may be determined based on these captured images or scanned data. For example, the monetary amount of a particular negotiable instrument and the endpoint, e.g., a bank or other financial institution, on which it was written might be determined based on the indicia.

The sorting process includes negotiable instruments being input into sorter 20, the indicia on the negotiable instruments being captured, and the negotiable instruments being distributed or sent, for example, using a conveyor belt or vacuum system 25, to pockets 40. Each one of pockets 40 might correspond to an endpoint, for example, an originating financial institution or owning bank, for each individual negotiable instrument. Further, the information captured is electronically stored indexed to individual pockets 40. For example, sorter 20 might operate under IBM's Check Processing Control System (CPCS), as is known by those skilled in the art.

Pockets 40 of sorter 20 might each hold a maximum amount of instruments, for example about 500. Thus, the pockets are periodically emptied of negotiable instruments to allow further instruments to be captured and sorted to individual pockets. The instruments removed from individual pockets may be packaged for sending to financial institutions. The instruments in each pocket might also be divided into bundles including one or more instruments to enable individual bundles to be removed and packaged for transport to the financial institutions while sorter 20 continues to operate.

One example of the sorting process will now be provided. As a pocket approaches a predetermined number of instruments or checks, for example about 300, a divider slip from an internal storage location in the sorter is sent to the particular pocket to separate one bundle from another bundle. For example, a divider slip may take the form of a colored piece of paper slightly larger than the size of a negotiable instrument to make them stand out for easier separation. The bundles then might be individually removed by hand or machine from a pocket for packaging and delivery to a financial institution. For example, the removed bundles might be collected in a box or a container or temporarily stored in a tray prior to shipment to the financial institution.

However, it is also industry practice to send with each bundle of negotiable instruments documentation disclosing the contents of the bundle to allow a receiving financial institution to determine the contents thereof. For example, such a document, or “kill list” as it is known by those skilled in the art, includes a monetary amount for each negotiable instrument and the name and identifying information of the desired endpoint thereof, for example, a bank name and address.

The use of kill lists and bundles help segment the work of the sorting process to ease reconcilement. Generally, a bundle represents the items which fit on a one page (e.g., 8½×11 inches) computer printout, i.e., a kill list. Further, it is desirable to generate or prepare kill lists concurrently with the sorting process. A sorter, for example, might be able to process about 2400 items per minute. By printing kill lists concurrently with the sorting process, as opposed to after such a process, the sorter may achieve an optimum amount of sorted items per unit time. This results because it is not necessary to stop the sorter to prepare a kill list, due to concurrent printing thereof Additional documents, known to those skilled in the art as “cash letters”, are also typically prepared, which summarize information relating to a number of related bundles. For example, a cash letter may include a summary of the monetary amounts of a collection of several bundles which are to be sent to a single bank or other endpoint. Kill lists might be wrapped around a bundle of checks prior to shipment and a cash letter might be included in a container with several of these bundles having kill lists wrapped around them.

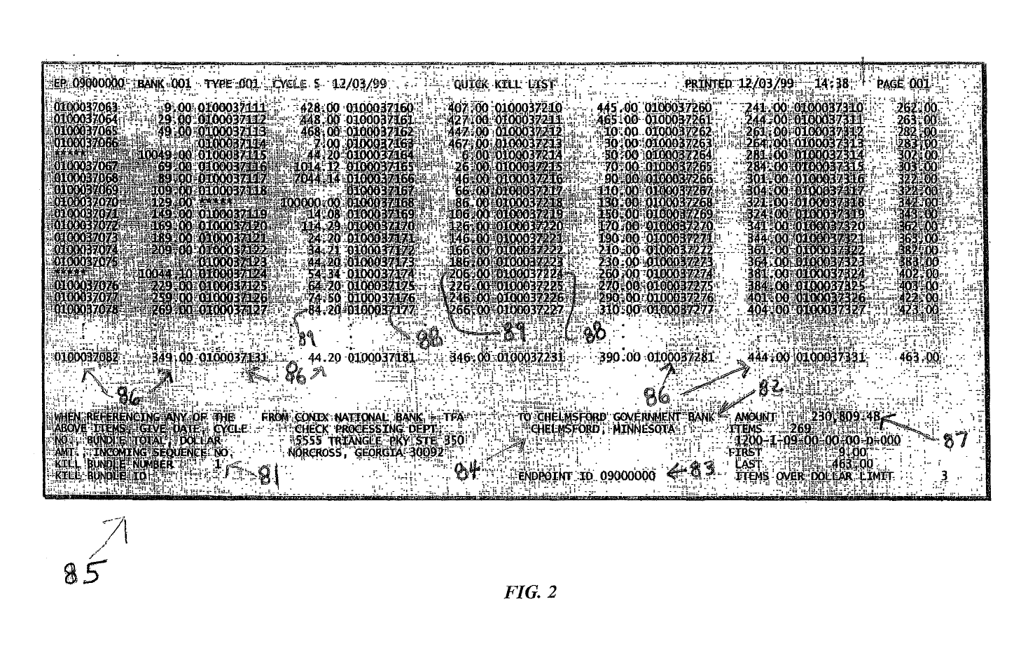

An example of a kill list 85 is depicted in FIG. 2. Kill list 85 might include information relating to individual negotiable instruments of a particular bundle, for example, a bundle identification number 81, a name 82 of a bank or endpoint, an identification number 83 for the bank or endpoint, and an address 84 of the endpoint. Further information might include a dollar amount 87 for all the items of the bundle. A sequence number 88 and a dollar amount 89, for each item in the bundle, may also be present. Sequence number 88 is an identification number assigned to each negotiable instrument as it is captured by sorter 20. Sequence number 88 and dollar amount 89 for the several items in the bundle may be arranged in several pairs of columns 86 with each sequence number in a first column of the pair of columns corresponding to a dollar amount in a second column of the pair of columns.

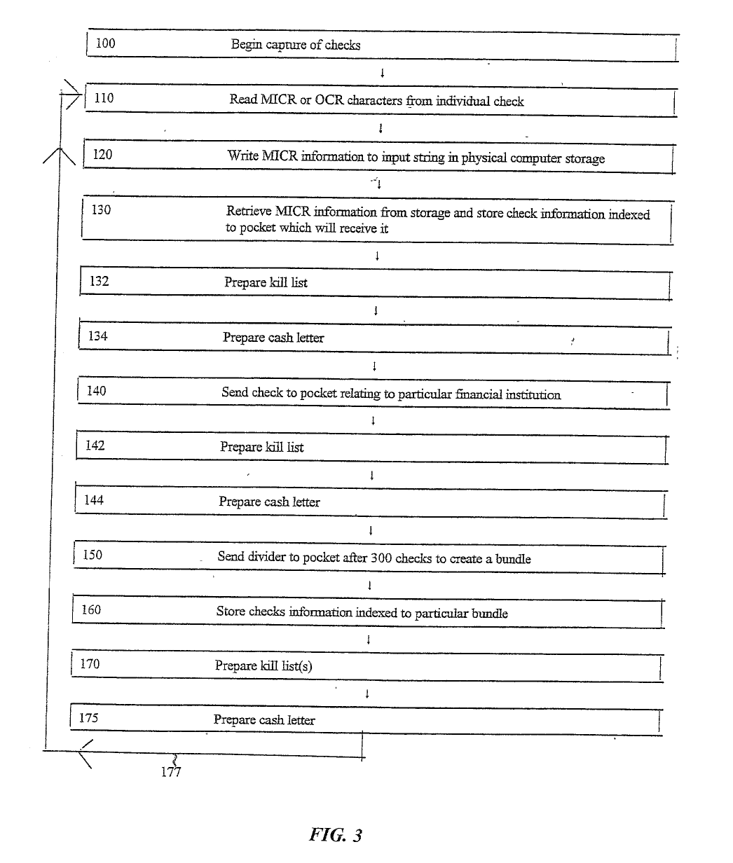

FIG. 3 is a flow diagram of an example of a sorting process in accordance with the present invention. At step 100, an operator starts a capture of a group of negotiable instruments, for example checks, by mechanically loading sorter 20 (FIG. 1). The capture includes reading the information on the face of the checks, by reading the MICR or OCR characters on the individual checks, as shown at step 110. The information relating to the checks is written to a computer file or string, e.g., an input-string (I-string), as the checks are captured, at step 120. The string may be stored on an electronic storage device integral to or separate from sorter 20 or computing unit 30, for example, on a hard disk drive of computing unit 30 or sorter 20, or on a remote server or mainframe. For example, such a string might be continuously created (i.e., one long output string) as negotiable instruments are captured using IBM's CPCS system. The string might also be continuously read and the information retrieved therefrom by computing unit 30, at step 130. Concurrently, computing unit 30 stores the information relating to each check indexed to the pocket to which it will be sent. The indexed information may also be stored on an electronic storage device integral to or separate from computing unit 30, for example, on a hard disk drive of computing unit 30 or on a remote server or mainframe. At step 140, the checks are distributed to pockets 40 of sorter 20 based on information read on the face of the checks. Each pocket is predesignated to receive checks for individual endpoints or to receive checks for end points not designated for the other pockets.

After a predetermined number of checks is deposited into a particular pocket, a divider is distributed thereto, for example, by a conveyor belt type mechanism (not shown), at step 150. Sorter controller 23 determines via a sensor (not shown), for example, that the divider has been distributed to a particular pocket. Computing unit 30 reads from the input string that the divider has been distributed and in step 160 saves information relating to the resultant bundle in a file indexed to that bundle. In one example this information is stored in two related files. A first file might be referred to as a Bundle Activity File, which may store individual MICR data items included in the bundle. A second file called, for example, a Bundle Control File may store bundle level information such as endpoint, sort type, source (e.g., the input string which the bundle originates from), pocket, total item count, and total amount.

Kill lists may thus be prepared for each bundle depending on the programming or operation of the computing unit by the operator. For example, a kill list may be prepared, in real time, as soon as a bundle is created by the sending of a divider to a particular pocket and the information is indexed to the particular bundle, at step 170. In another example, kill lists may be prepared after several bundles have been created. In yet another example, kill lists may be prepared when enough bundles have been created to fill a shipping container. Further, cash letters may also be prepared after several bundles have been created at step 175. This process may run continuously as indicated by an arrow 177 from step 170 to step 110 and kill lists and cash letters may be generated at any point in the process (e.g., steps 132, 134, 142, 144, 170, and 175) on an ad hoc basis by an operator. Further, the process of generating kill lists and cash letters may also be automatic, based on the preprograming of the computing unit.

In addition to storing information relating to particular negotiable instruments and indexing them to particular bundles, the information may also be compared to preset criteria. For example, the information captured from the negotiable instruments may be electronically compared to a predetermined monetary amount criteria programmed into the computing unit, for example, by the operator. Bundles containing negotiable instruments exceeding the predetermined monetary amount criteria or a group of negotiable instruments exceeding such criteria may cause the automatic preparation of kill lists, cash letters, and/or other resultant documents reporting on the comparison. The creation of these documents during the sorting process may decrease the amount of time taken to process the instruments and send them to their financial institution. As one skilled in the art will appreciate, this decrease in time may allow the strategic selection of courier services and/or shipping types to reduce or eliminate large float times for instruments having high dollar amounts. A float time refers to the time period between a check being endorsed and the relevant funds being transferred from the account on which the check was drawn, as will be evident to those skilled in the art.

In a further example, it may be desirable to print kill lists on printer 37 (FIG. 1) as soon as a bundle for a particular bank has been completed. Information encoded on negotiable instruments and captured therefrom may thus be compared to a preset criteria relating to one or more financial institutions and on completion of a bundle for a particular bank, a kill list relating thereto may be prepared either on demand or automatically while the sorter continues to process negotiable instruments.

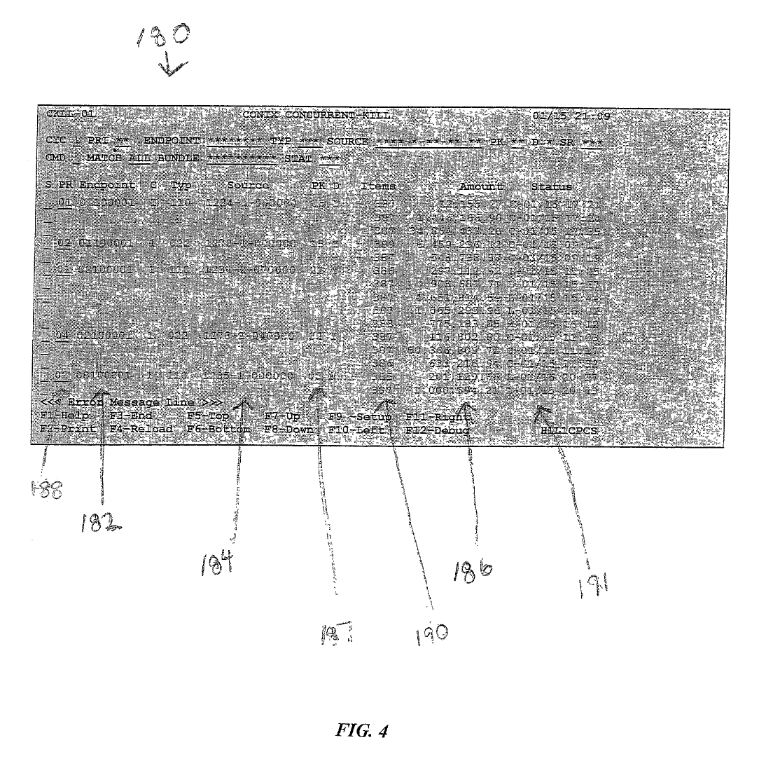

Further, the information captured during the sorting process may be immediately displayed and viewed by an operator viewing a kill display 180 (FIG. 4) on display 35 coupled to computing unit 30 (FIG. 1). An example of the information that may be depicted on kill display 180 is illustrated in FIG. 4. This information may include, for example, an end point identification number 182, a source 184 (e.g., an output string identification number), a bundle monetary amount 186, a pocket identification number 187, a priority 188 of discharge or kill from the sorter, and a number of items 190 in a particular bundle. Further information might include a status 191 which may indicate the status of a bundle. Particularly, it may indicate a bundle has been captured but a kill list has not been generated (M), a kill list has been generated for a bundle but no cash letter has been prepared (L), a bundle has had a cash letter prepared (C), or a kill list has been requested but the kill list has not yet been prepared (R).

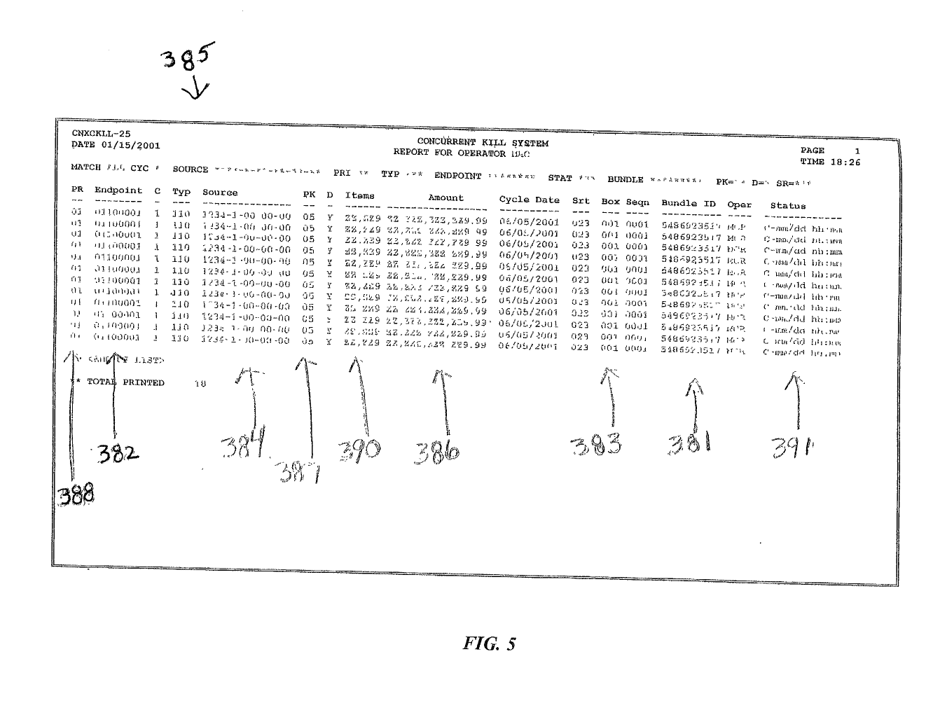

An example of a status report 385 which an operator may cause to be printed from kill display 180 is depicted in FIG. 5. Status report 385 may include information relating to individual negotiable instruments of a particular bundle, for example, a bundle identification number 381, a box number 383, an end point identification number 382, and a source 384 (e.g., input string identification number). Further information may include a monetary amount 386, a pocket identification number 387, a priority 388 of discharge or kill from the sorter, a number of items 390 in a particular bundle and a status 391. Status 391 indicates the status of a bundle, as described above relating to FIG. 4. Status reports may be printed by a printer 37 coupled to computing unit 30, as depicted in FIG. 1.

For example, the operator may view the information relating to checks concurrent with the information being read from the checks or it may be viewed on a bundle by bundle basis as depicted in kill display 180 in FIG. 4, as soon as the bundles are created. Thus, an operator might view information relating to the bundles or checks and, based on an analysis thereof, cause a kill list or cash letter to be generated for particular bundle or group of bundles. For example, the operator may change priority 188 to a higher priority, by pointing and selecting and/or typing a new priority number for example, such that a kill list for a particular bundle may be generated. Also, the bundles might be sorted and viewed on display 35 according to certain criteria, such as, for example, their kill priority, endpoint, sort type, source, pocket, sorter, bundle identification number and/or status.

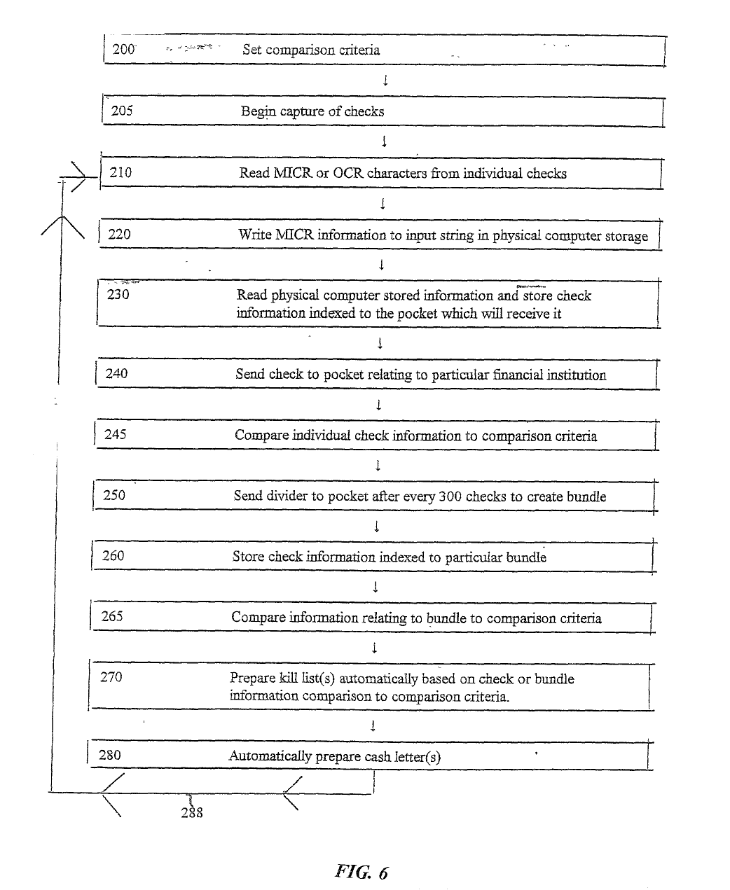

FIG. 6 is a flow diagram of an example of a sorting process using system 10, in accordance with the present invention, which includes comparing captured information to a pre-set comparison or discharge criteria. This criteria is set, for example, by an operator through programming computing unit 30 via a system set up screen, for example, a xref-setup (not shown), at step 200. The operator then begins the capture of checks by inputting a supply of checks into a sorter 20, at step 205. MICR or OCR characters are read from the individual checks by sorter 20 and stored to an input string in an electronic storage device, at steps 210-220. Based on the information read from the checks, they are sent to individual pockets 40 relating to particular financial institutions, at step 230. Also, at step 230, computing unit 30 reads or retrieves information written to the string by sorter 20, which may include a CPCS system, for example, and concurrently stores the information indexed to the pockets to which they will be sent (at step 240). The information may be stored on an electronic storage device integral to or separate from computing unit 30, for example, on a hard disk drive of computing unit 30, a remote server, or a mainframe. At step 245, the information relating to individual documents is compared by computing unit 30 to the pre-set criteria which may include a monetary amount or a desired endpoint, (e.g., a particular financial institution) for example. Dividers are sent to the pockets after a pre-determined number of negotiable instruments have been received at a particular pocket, at step 250. Further, information relating to particular negotiable instruments is then indexed to bundles created by the dividers, at step 260. Bundle information may then be compared to the pre-set criteria, at step 265. Kill lists may automatically be created, at step 270, based on collected bundle information. At step 280, cash letters might also be automatically prepared relating to several of the bundles based on the comparisons. Some or all of the steps in FIG. 6 may be performed simultaneously. The sorter may be run continuously, as indicated by an arrow 288 between step 280 and step 210, and kill lists and cash letters may be generated at any point during the process.

Additionally, multiple sorters may be utilized in a process embodying the present invention. Often, it is necessary to send negotiable instruments having different endpoints (e.g., banks) to the same sorter and/or pocket when a quantity of instruments input to the sorter does not include many instruments to be sent to a particular endpoint relative to a total number of instruments and a limited quantity of pockets. Thus, during a first pass through a sorter, a pocket may receive checks or instruments relating to more than one endpoint or financial institution. In one example, while the sorter is still running, these instruments may be packaged together and removed from the sorter pocket. These instruments belonging to several financial institutions may, however, be then introduced by a user into a second sorter. They will be read by the sorter and sent to different pockets of the second sorter based upon the MICR or OCR data on each document. In this case, they will be re-indexed by the controller, which is coupled to one or more of the sorters in use, from the pockets and bundles which they were indexed to in the first sorter and instead indexed to pockets and bundles of the second sorter.

In an example utilizing one sorter, negotiable instruments may be passed through this single sorter more than once. During the first or prime pass, negotiable instruments relating to more than one endpoint or financial institution may be sorted to a particular pocket. Those instruments sorted to a pocket containing instruments belonging to more than one institution may then be introduced to the sorter a second time. Prior to this introduction, the sorter may be reprogrammed directly by the operator or indirectly by the computing unit, previously configured by the operator, to allow these instruments to be sent to different pockets on their second or subsequent pass through the sorter. In another example, a document may be introduced to the sorter to signal to the sorter controller which pockets are to receive negotiable instruments for which endpoints.

In another example, sorter 20 may include only a reader or scanner for obtaining information from negotiable instruments, for example, indicia on the face thereof This information may thus be read from the negotiable instruments and stored in an electronic storage device. The information may then be retrieved by computing unit 30 and indexed relative to the endpoints read from the surface of the negotiable instruments. This indexed information may be supplied to the financial institutions or endpoints without the necessity of supplying the negotiable instruments themselves. The negotiable instruments may be sorted as described above for particular endpoints. These instruments may then be stored for a certain time period in the event it was necessary to produce them. Alternatively, the negotiable instruments may be read or scanned and then stored in the manner they were held prior to the reading or scanning, without actual physical sorting.

It will be understood by those skilled in the art that the above methods and processes could be used for negotiable instruments of all types. For example, checks, food stamps, money orders, travelers checks, or other such documents. Also, it will also be understood by those skilled in the art that operations other than indexing may be performed on information retrieved from electronic storage resulting from the reading of negotiable instruments. Further, indexing may be performed relative to information other than endpoints. For example, information retrieved might be indexed in categories resulting from ranges of monetary amounts.

The above-described computing environment regarding the computing unit and a negotiable instrument processing system are only offered as examples. The present invention can be incorporated and used with many types of computing units, computers, processors, nodes, systems, work stations, sorters, scanners and/or environments without departing from the spirit of the present invention. For example, sorter controller 23 could perform some of the functions of computing unit 30 and/or computing unit 30 could perform some of the functions of sorter controller 23.

The embodiments described herein are just examples. There may be many variations to the methods and/or devices described herein without departing from the spirit of the invention. For instance, the operational steps may be performed in a different order, or steps may be added, deleted, or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

1. A method of sorting negotiable instruments comprising:
electronically obtaining information from a plurality of negotiable instruments;
electronically storing the information;
electronically retrieving at least some of the information; and
electronically storing the at least some of the information indexed to at least one location.

2. The method of claim 1 wherein the at least one location comprises at least one endpoint.

3. The method of claim 2 wherein the electronically obtaining, the electronically storing the information, the electronically retrieving, and the electronically storing the at least some of the information occur concurrently.

4. The method of claim 2, further comprising providing the at least some of the information indexed to the at least one endpoint.

5. The method of claim 1 further comprising:
sending the plurality of negotiable instruments to the at least one location based on the information.

6. The method of claim 5 wherein the sending and the electronically storing the at least some of the information indexed to the at least one location are performed concurrently to the electronically obtaining, the electronically storing the information and the electronically retrieving the stored information.

7. The method of claim 5, further comprising providing the at least some of the information indexed to the at least one location.

8. The method of claim 7, wherein the providing comprises displaying the at least some of the information indexed to the at least one location on a display screen.

9. The method of claim 8, further comprising generating a kill list by inputting a command based on the displaying.

10. The method of claim 7, wherein the providing comprises automatically generating a kill list.

11. The method of claim 7 wherein the providing, the sending, and the electronically storing the at least some of the information indexed to the at least one location occur concurrently to the electronically obtaining the information, the electronically storing the information, and the electronically retrieving the at least some of the information.

12. The method of claim 1, further comprising electronically comparing the at least some of the stored information indexed to the at least one location to at least one discharge criteria.

13. The method of claim 12, further comprising providing at least one result of the comparing.

14. The method of claim 12, wherein the providing occurs concurrently to the electronically obtaining, the electronically storing the information, the electronically retrieving and the electronically storing the at least some of the information indexed to the at least one location.

15. The method of claim 13, wherein the providing comprises printing the at least one result.

16. The method of claim 13, wherein the providing comprises displaying the at least one result on a display screen.

17. The method of claim 13, wherein the providing comprises generating a kill list relating to at least one negotiable instrument of the plurality of negotiable instruments.

18. The method of claim 5 further comprising dividing the plurality of negotiable instruments in the at least one location into a plurality of bundles based on the information.

19. The method of claim 18, wherein the dividing comprises placing at least one divider between the plurality of bundles.

20. The method of claim 18, wherein the electronically storing the at least some of the information indexed to the at least one location further comprises electronically storing the at least some of the information indexed to at least one bundle of the plurality of bundles.

21. The method of claim 20, wherein the electronically storing the at least some of the information indexed to the at least one bundle is performed in response to the dividing.

22. The method of claim 20, further comprising generating a kill list for the at least one bundle of the plurality of bundles.

23. The method of claim 22, wherein the generating, the sending, the storing the at least some of the information indexed to the at least one bundle and the dividing occur concurrently to the electronically obtaining, the electronically storing the information, and the electronically retrieving.

24. The method of claim 18 further comprising providing a status of at least one bundle of the plurality of bundles.

25. The method of claim 24 wherein the providing comprises displaying a status on a display screen.

26. The method of claim 20, further comprising electronically comparing the at least some of the information indexed to the at least one bundle of the plurality of bundles to at least one discharge criteria.

27. The method of claim 26, further comprising providing at least one result of the comparing.

28. The method of claim 27, wherein the providing, the sending, the dividing, the comparing, and the storing the at least some of the information indexed to the at least one bundle occur concurrently to the electronically obtaining, the electronically storing the information, and the electronically retrieving.

29. The method of claim 25, wherein the providing comprises generating a kill list for at least one bundle of the plurality of bundles.

30. The method of claim 27, wherein the providing comprises automatically generating at least one of a kill list and a cash letter based on the comparing.

31. The method of claim 29, further comprising generating a cash letter relating to the at least one bundle.

32. The method of claim 29, wherein the information comprises an identifier for at least one endpoint and the method further comprises sending the at least one bundle and the kill list to the at least one endpoint.

33. The method of claim 26, wherein the at least one discharge criteria comprises at least one of a monetary amount criteria and an endpoint.

34. The method of claim 1, wherein the electronically obtaining comprises electronically identifying indicia on the plurality of negotiable instruments.

35. The method of claim 34, wherein the electronically identifying comprises optically scanning the identifying indicia on the plurality of negotiable instruments.

36. The method of claim 35, wherein the identifying indicia comprises at least one of a monetary amount and at least one endpoint.

37. The method of claim 1, wherein the information comprises at least one of a monetary amount and at least one endpoint.

38. The method of claim 5, wherein the at least one location comprises at least one pocket of an apparatus for sorting negotiable instruments.

39. A system for sorting negotiable instruments comprising:
means for electronically obtaining information from a plurality of negotiable instruments;
means for electronically storing the information;
means for electronically retrieving at least some of the stored information; and
means for electronically storing the at least some of the stored information indexed to at least one location.

40. The system of claim 39 wherein the at least one location comprises at least one endpoint.

41. The system of claim 40, wherein the means for electronically obtaining, the means for electronically storing, the means for electronically retrieving, and the means for electronically storing the at least some of the stored information indexed to the at least one endpoint are adapted to operate concurrently.

42. The system of claim 40 further comprising means for providing the at least some of the stored information indexed to the at least one endpoint.

43. The system of claim 39 further comprising means for sending the plurality of negotiable instruments to the at least one location based on the information.

44. The system of claim 43 wherein the means for electronically obtaining, the means for electronically storing, and the means for electronically sending comprise a sorter; and the means for electronically retrieving and the means for electronically storing the at least some of the stored information indexed to the at the least one location comprise a computing unit.

45. The system of claim 44, further comprising a display screen, wherein the computing unit is adapted to cause the display screen to display the at least some of the stored information indexed to the at least one location.

46. The system of claim 44, further comprising a printer, and wherein the computing unit is adapted to cause the printer to generate a kill list.

47. The system of claim 45 wherein the computing unit is adapted to receive a command input by a user based on the displaying to cause the printer to generate a kill list.

48. The system of claim 44, wherein the computing unit is adapted to compare the at least some of the stored information to at least one discharge criteria.

49. The system of claim 48, wherein the computing unit is adapted to provide at least one result of the comparing.

50. The system of claim 49, wherein the sorter and the computing unit are adapted to cause the providing, the sending, and the electronically storing the at least some of the information indexed to the at least one location to occur concurrently to the electronically obtaining, the electronically storing, and the electronically retrieving.

51. The system of claim 49, further comprising a printer, and wherein the computing unit is adapted to cause the printer to print the at least one result.

52. The system of claim 49, further comprising a display screen, and wherein the computing unit is adapted to cause the display screen to display the at least one result.

53. The system of claim 49, wherein the at least one result comprises a kill list relating to at least one negotiable instrument of the plurality of negotiable instruments.

54. The system of claim 44, wherein the sorter is adapted to divide the plurality of negotiable instruments in the at least one of location into a plurality of bundles based on the information.

55. The system of claim 54 wherein the computing unit is adapted to provide a status of at least one bundle of the plurality of bundles.

56. The system of claim 55 further comprising a display screen and wherein the computing unit is adapted to provide the status on the display screen.

57. The system of claim 54, wherein the dividing by the sorter comprises the sorter causing at least one divider to be placed between the plurality of bundles.

58. The system of claim 54, wherein the computing unit is adapted to store the at least some of the stored information indexed to at least one bundle of the plurality of bundles.

59. The system of claim 58, wherein the computing unit is adapted to store the at least some of the information indexed to the at least one bundle in response to the dividing by the sorter.

60. The system of claim 58, further comprising a printer, wherein the computing unit is adapted to cause the printer to generate a kill list for the at least one bundle of the plurality of bundles.

61. The system of claim 60, wherein the computing unit and the sorter are adapted to cause the generating, the electronically obtaining, the sending, the storing the at least some of the information indexed to the at least one bundle, the electronically storing the information and the electronically retrieving to occur concurrently.

62. The system of claim 58, wherein the computing unit is adapted to compare the at least some of the information indexed to the at least one bundle of the plurality of bundles to at least one discharge criteria.

63. The system of claim 62, wherein the computing unit is adapted to provide at least one result of the comparing.

64. The system of claim 63, wherein the computing unit and the sorter are adapted to cause the providing, the electronically obtaining, the sending, the comparing, the storing the at least some of the information indexed to the at least one bundle, the electronically storing the information, and the retrieving to occur concurrently.

65. The system of claim 63, wherein the computing unit is adapted to provide by causing a kill list to be generated for the at least one bundle.

66. The system of claim 63, wherein the computing unit is adapted to provide a cash letter relating to the at least one bundle.

67. The system of claim 65, further comprising a printer and wherein the computing unit is adapted to provide by causing the printer to print at least one of the kill list and a cash letter.

68. The system of claim 44, wherein the electronically obtaining by the sorter comprises the sorter electronically identifying indicia on the plurality of negotiable instruments.

69. The system of claim 68, wherein the electronically identifying by the sorter comprises the sorter optically scanning the identifying indicia on the plurality of negotiable instruments.

70. The system of claim 68, wherein the identifying indicia comprises at least one of a monetary amount and at least one endpoint.

71. The system of claim 44, wherein the at least one location comprises at least one pocket of the sorter.

72. At least one program storage device readable by a machine, tangibly embodying at least one program of instructions executable by the machine to perform a method for sorting negotiable instruments, the method comprising:
electronically obtaining information from a plurality of negotiable instruments;
electronically storing the information;
electronically retrieving at least some of the stored information; and
electronically storing the at least some of the information indexed to at least one location.

73. The at least one program storage device of claim 72, wherein the at least one location comprises at least one endpoint.

74. The at least one program storage device of claim 73, wherein the electronically obtaining, the electronically storing, the electronically retrieving and the electronically storing the at least some of the information indexed to the at least one endpoint occur concurrently.

75. The at least one program storage device of claim 73, wherein the method further comprises providing the at least some of the information indexed to the at least one endpoint.

76. The at least one program storage device of claim 72 wherein the method further comprises:
sending the plurality of negotiable instruments to the at least one location based on the information.

77. The at least one program storage device of claim 76 wherein the sending and the electronically storing the at least some of the information indexed to the at least one location are performed concurrently to the electronically storing the information, the electronically obtaining and the electronically retrieving the stored information.

78. The at least one program storage device of claim 76, wherein the method further comprises providing the at least some of the information indexed to the at least one location.

79. The at least one program storage device of claim 78, wherein the providing comprises displaying the at least some of the information on a display screen.

80. The at least one program storage device of claim 79, wherein the method further comprises causing a kill list to be generated by inputting a command based on the disiplaying.

81. The at least one program storage device of claim 78, wherein the providing comprises generating a kill list.

82. The at least one program storage device of claim 78, wherein the providing, the sending, and the electronically storing the at least some of the information indexed to the at least one location occur concurrently to the electronically obtaining the information, the electronically storing the information, and the electronically retrieving the at least some of the information.

83. The at least one program storage device of claim 72, wherein the method further comprises electronically comparing the at least some of the stored information indexed to the at least one location to at least one discharge criteria.

84. The at least one program storage device of claim 83 wherein the method further comprises providing at least one result of the comparing.

85. The at least one program storage device of claim 84, wherein the providing, the sending, the comparing, the electronically obtaining, the electronically storing the information, the electronically storing the at least some of the information and the electronically retrieving occur concurrently.

86. The at least one program storage device of claim 84 wherein the providing comprises printing the at least one result.

87. The at least one program storage device of claim 84, wherein the providing comprises displaying the at least one result on a display screen.

88. The at least one program storage device of claim 84, wherein the providing comprises generating a kill list relating to at least one negotiable instrument of the plurality of negotiable instruments.

89. The at least one program storage device of claim 72, wherein the method further comprises dividing the plurality of negotiable instruments in the at least one location into a plurality of bundles based on the information.

90. The at least one program storage device of claim 89, wherein the dividing comprises placing at least one divider between the plurality of bundles.

91. The at least one program storage device of claim 89, wherein the electronically storing further comprises storing the at least some of the information indexed to at least one bundle of the plurality of bundles.

92. The at least one program storage device of claim 91, wherein the storing the at least some of the information indexed to the at least one bundle is performed in response to the dividing.

93. The at least one program storage device of claim 91, wherein the method further comprises generating a kill list for the at least one bundle of the plurality of bundles.

94. The at least one program storage device of claim 93, wherein the generating, the sending, the storing the at least some of the information indexed to the at least one bundle occur concurrently to the electronically obtaining, the electronically storing the information, and the electronically retrieving.

95. The at least one program storage device of claim 89, wherein the method further comprises providing a status of at least one bundle of the plurality of bundles.

96. The at least one program storage device of claim 95, wherein the providing comprises displaying a status on a display screen.

97. The at least one program storage device of claim 91, wherein the method further comprises electronically comparing the at least some of the information indexed to the at least one bundle of the plurality of bundles to at least one discharge criteria.

98. The at least one program storage device of claim 97, wherein the method further comprises providing at least one result of the comparing.

99. The at least one program storage device of claim 98, wherein the providing, the sending, the comparing, and the storing the at least some of the information indexed to the at least one bundle occur concurrently to the electronically obtaining, the electronically storing the information, and the electronically retrieving.

100. The at least one program storage device of claim 98, wherein the providing comprises generating a kill list for at least one bundle of the plurality of bundles.

101. The at least one program storage device of claim 98, wherein the providing comprises automatically generating at least one of a kill list and a cash letter based on the comparing.

102. The at least one program storage device of claim 100, wherein the method further comprises generating a cash letter relating to the at least one bundle.

103. The at least one program storage device of claim 97, wherein the at least one discharge criteria comprises at least one of a monetary amount criteria and an endpoint.

104. The at least one program storage device of claim 72, wherein the electronically obtaining comprises electronically identifying indicia on the plurality of negotiable instruments.

105. The at least one program storage device of claim 104, wherein the electronically identifying comprises optically scanning the identifying indicia on the plurality of negotiable instruments.

106. The at least one program storage device of claim 105, wherein the identifying indicia comprises at least one of a monetary amount and at least one endpoint.

107. The at least one program storage device of claim 72, wherein the information comprises at least one of a monetary amount and at least one endpoint.

108. The at least one program storage device of claim 72, wherein the at least one location comprises a pocket of an apparatus for sorting negotiable instruments.
